(19) United States
(12) Patent Application Publication
(10) Pub. No.: US 2023/0096778 A1
(43) Pub. Date: Mar. 30, 2023

(54) ANION-SOLVATING POLYMER MEMBRANES

(71) Applicant: Rensselaer Polytechnic Institute, Troy, NY (US)

(72) Inventors: Chulsung Bae, Cohoes, NY (US); Gregory Kline, Cohoes, NY (US)

(21) Appl. No.: 17/758,767

(22) PCT Filed: Jan. 22, 2021
(86) PCT No.: PCT/US2021/014759

§ 371 Date: Jul. 13, 2022

Related U.S. Application Data
(60) Provisional application No. 62/964,478, filed on Jan. 22, 2020.

(51) Int. Cl. C08F 277/00

(52) U.S. Cl. CPC C08F 277/00

(57) ABSTRACT

The present disclosure relates, in part, to polymers having a graft chain and/or a cyclic amino group. In particular examples, the graft chain and/or the cyclic amino group provides enhanced hydrophilicity, alkaline stability, and/or anion solvation. Compounds, compositions, and methods are described herein.

### CROSS-REFERENCE TO RELATED APPLICATION

This application claims the benefit of U.S. Provisional Patent Application No. 62/964,478, filed Jan. 22, 2020, which is incorporated herein by reference in its entirety.

### STATEMENT REGARDING FEDERALLY SPONSORED RESEARCH OR DEVELOPMENT

This invention was made with government support under contract number DE-AR0000769 awarded by the Advanced Research Projects Agency-Energy (ARPA-E). The government has certain rights in the invention.

### FIELD

The present disclosure relates, in part, to polymers having a graft chain and/or a cyclic amino group. In particular examples, the graft chain and/or the cyclic amino group provides enhanced hydrophilicity, alkaline stability, and/or anion solvation. Compounds, compositions, and methods are described herein.

### BACKGROUND

Currently, alkaline water electrolyzers are the most mature technology for large-scale “clean” hydrogen production (besides CO₂-emitting methane cracking or coal gasification). This is due to their robustness and relative “low-cost” of the technology. Alkaline electrolyzers can use lower cost, non-noble metal catalysts (e.g., Ni, Fe) in their electrodes in contrast to platinum group metal catalysts (e.g., Pt, Ir) in acidic proton exchange membrane (PEM) electrolyzers. Furthermore, current capital costs and projected future capital costs of alkaline electrolysis are less than those of PEM electrolysis. It has also been reported that the lifetime of state-of-the-art alkaline electrolyzer stack and system is significantly longer than those of PEM electrolyzers.

An alkaline electrolyzer cell can include an electrolyte (such as concentrated KOH solution), two electrodes—the cathode and the anode, and a separator, which isolate the two electrodes from one another. Typical operating conditions of alkaline electrolyzers include the use of a 20-30% aqueous KOH solution with operation temperature normally at about 80° C. or below. In addition, large pressure differentials may exist across the diaphragm. The diaphragm, or separator, of alkaline electrolyzers can include the following four major properties: (1) Due to potential harsh operating conditions, it can have high chemical stability (to withstand high pH condition) and high mechanical stability. (2) The separator can also exhibit high porosity but small pore size to increase anionic conductivity, but limit gas crossover. (3) The separator can have good “wettability,” which enables high anionic transport and lower gas mixing. (4) The separator can have low gas permeability to limit gas crossover.

The conventional diaphragm material of alkaline electrolyzers used to be asbestos. However, due to its limited chemical stability at high temperatures and its toxicity, asbestos membranes are no longer used. Currently, commercial diaphragm material Zirfon® is a common replacement of asbestos. Zirfon® includes polysulfone polymer matrix with embedded hydrophilic ZrO₂ particles. Other materials such as poly(tetrafluoroethylene), poly(phenylene sulfide), polypropylene, and various poly(arylene ether)s have also been investigated to replace asbestos. Unfortunately, alkaline stability studies of these commercial membrane materials have been tested at temperatures below 100° C. (usually at 80° C. or lower). From a commercial viability standpoint, it may be highly advantageous to operate alkaline electrolyzers at significantly higher temperatures than 80° C. For instance, higher temperature operation promotes substantially faster kinetics for both electrode reactions while also increasing the conductivity of the electrolyte. Furthermore, ohmic resistance decreases with increasing temperature, which is advantageous. However, there are also major drawbacks, where operation at higher temperature leads to accelerated chemical degradation and potentially reduced mechanical properties of the diaphragm. In addition, if the concentration of the electrolyte is increased (e.g., KOH is increased to up to 50%), then chemical degradation can be accelerated.

In order for alkaline electrolyzers to operate under harsh conditions (e.g., 6-12 M KOH at a temperature of 90-140° C.), more mechanically robust and chemically stable polymeric materials can be considered for use as the diaphragm. There have been a few studies which report high chemical stability of sulfonated poly(ether ether ketone) or polysulfone under high pH conditions. However, none of these studies were conducted at temperatures above 90° C. Furthermore, polymers with aryl ether bonds in their backbone have shown poor chemical stability in KOH solutions (FIG. 1). For example, when polysulfone is dissolved in a solvent (or swelled by favorable wetting), it showed significant polymer backbone degradation by KOH attack. In contrast, polymers without aryl ether bonds in the backbone remained stable under the same condition. Thus, employing polymeric materials of alternative types has been of recent interest for membrane applications in alkaline conditions.

Hydroxide solvating membranes represents a new direction in the field of alkaline polymer electrolytes (FIG. 2c). This class of materials combines the conductive properties of the alkaline salt solution with the mechanical robustness of the polymer membrane. The membrane remains dense and gas-tight, which in turn allows for thinner membranes and therefore reduced internal resistance. Using this innovative concept and cells constructed around the membranes, an alkaline cell performance comparable to that of state-of-the-art PEM electrolyzers has been achieved in completely noble-metal free systems. However, the need remains for polymer chemistries with lifetimes that are of technological and economical relevance.

### SUMMARY

The present disclosure relates to polymers and membranes thereof. In a first aspect, the present disclosure includes a compound having a structure of formula (I):

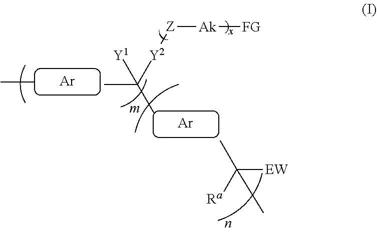

or a salt thereof,

wherein:
each Ar includes, independently, an optionally substituted aromatic or optionally substituted arylene;
each Y¹ is, independently, an electron-withdrawing moiety (e.g., EW) and each Y² is, independently, an optionally substituted alkylene (e.g., Ak); or Y¹ and Y², taken together, includes an optionally substituted heterocyclic amino;
each Z is, independently, selected from the group consisting of —O—, —S—, —NR^{N1}—, —NR^{N1}R^{N2}—, and —CR^{C2}R^{C3}—, in which each of R^{N1}, R^{N2}, R^{C2}, and R^{C3} is, independently, H, optionally substituted alkyl, or optionally substituted aryl;
each Ak is, independently, optionally substituted alkylene;
x is 1 to 20;
each FG is, independently, a functional group (e.g., any described herein);
each EW is, independently, an electron-withdrawing group (e.g., any described herein);
each R^{a} is, independently, H, optionally substituted alkyl, optionally substituted aryl, or optionally substituted heteroaryl; and
each of m and n is, independently, 1 to 1,000,000.

In some embodiments, Z (e.g., at least one Z or every Z) is not —CR^{C2}R^{C3}. In other embodiments, Z (e.g., at least one Z or every Z) is not —CH₂—. In some embodiments, Z (e.g., at least one Z or every Z) is not —NR^{N1}R^{N2}—. In other embodiments, Z (e.g., at least one Z or every Z) is not —N(CH₃)₂—.

In some embodiments, each FG is, independently, selected from the group consisting of optionally substituted alkyl, optionally substituted aryl, hydroxy, amino, ammonium cation, sulfo, sulfonate anion, phosphono, phosphonate anion, carboxyl, carboxylate anion, heterocyclic cation, or a salt form thereof. In other embodiments, each EW is, independently, selected from the group consisting of haloalkyl, optionally substituted heteroaryl, amino, amido, nitrile, and —C(═O)R^{C1}, in which R^{C1} is H, hydroxy, alkoxy, alkyl, or oxygen anion (O⁻).

In some embodiments the compound includes a structure of formula (II):

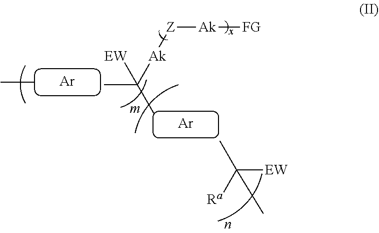

or a salt thereof. In particular embodiments, —(Z-Ak)ₓ-FG (e.g., at least one or every —(Z-Ak)ₓ-FG) is not —(N(CH₃)₂—(CH₂)₅)ₓ—N(CH₃)₃ or not —N(CH₃)₂—(CH₂)₅—N(CH₃)₃. In other embodiments, —(Z-Ak)ₓ-FG (e.g., at least one or every —(Z-Ak)ₓ-FG) is not —(N(CH₃)₂—(CH₂)₆)ₓ—N(CH₃)₃ or not —N(CH₃)₂—(CH₂)₆—N(CH₃)₃. In some embodiments, -Ak-(Z-Ak)ₓ-FG (e.g., at least one or every -Ak-(Z-Ak)ₓ-FG) is not —(CH₂)₅—(N(CH₃)₂—(CH₂)₅)ₓ—N(CH₃)₃ or not —(CH₂)₅—N(CH₃)₂—(CH₂)₅—N(CH₃)₃. In other embodiments, -Ak-(Z-Ak)ₓ-FG (e.g., at least one or every -Ak-(Z-Ak)ₓ-FG) is not —(CH₂)₅—(N(CH₃)₂—(CH₂)₆)ₓ—N(CH₃)₃ or not —(CH₂)₅—N(CH₃)₂—(CH₂)₆—N(CH₃)₃. In yet other embodiments, -Ak-(Z-Ak)ₓ-FG (e.g., at least one or every -Ak-(Z-Ak)ₓ-FG) is not —(CH₂)₆—(N(CH₃)₂—(CH₂)₆)ₓ—N(CH₃)₃ or not —(CH₂)₆—N(CH₃)₂—(CH₂)₆—N(CH₃)₃.

In other embodiments, the compound includes a structure of formula (IIa):

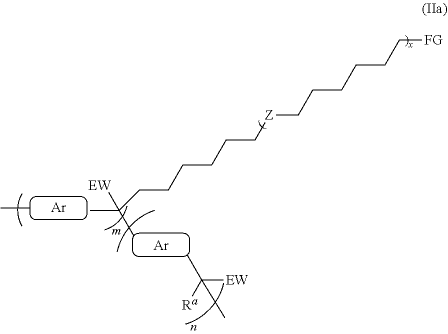

or a salt thereof. In some embodiments (e.g., of formula (IIa)), each EW is, independently, selected from the group consisting of CF₃, pyridine, heterocyclic amino, —C(═O)OH, amido, and nitrile; and/or each Z is selected from the group consisting of —O—, —S—, —NH—, and —CH₂—; and/or each FG is selected from the group consisting of CH₃, CH₂CH₃, alkyl, aryl, OH, NR^{N1}R^{N2}R^{N3}, SO₃H, P(═O)(OH)₂, CO₂H, NR^{N1}R^{N2}R^{N3} Cl, and NR^{N1}R^{N2}R^{N3} Br, in which each of R^{N1}, R^{N2}, and R^{N3} is, independently, H, optionally substituted alkyl, or optionally substituted aryl. In other embodiments, each of R^{N1}, R^{N2}, and R^{N3} is, independently, H or optionally substituted alkyl.

In some embodiments, the compound includes a structure of formula (IIb)-(IIe):

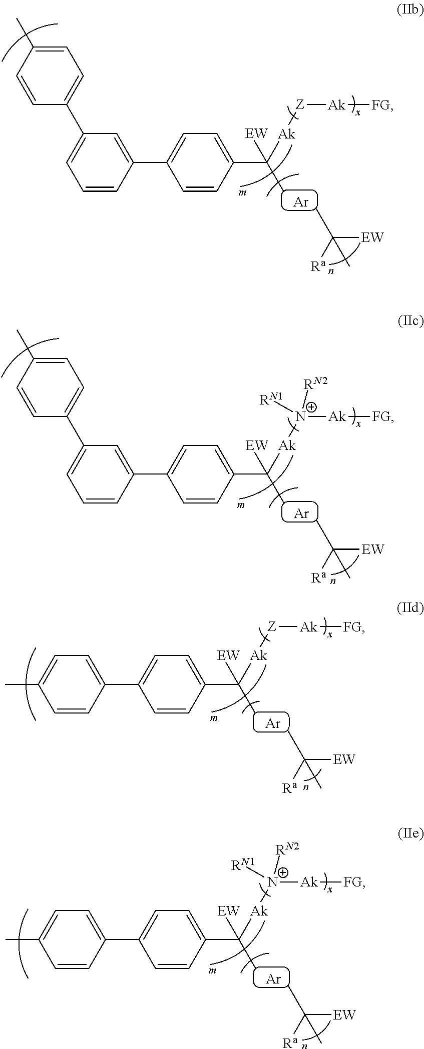

or a salt thereof. In particular embodiments, —(Z-Ak)ₓ-FG (e.g., at least one or every —(Z-Ak)ₓ-FG) is not —(N(CH₃)₂—(CH₂)₅)ₓ—N(CH₃)₃ or not —N(CH₃)₂—(CH₂)₅—N(CH₃)₃. In other embodiments, —(Z-Ak)ₓ-FG (e.g., at least one or every —(Z-Ak)ₓ-FG) is not —(N(CH₃)₂—(CH₂)₆)ₓ—N(CH₃)₃ or not —N(CH₃)₂—(CH₂)₆—N(CH₃)₃. In some embodiments, -Ak-(Z-Ak)ₓ-FG (e.g., at least one or every -Ak-(Z-Ak)ₓ-FG) is not —(CH₂)₅—(N(CH₃)₂—(CH₂)₅)ₓ—N(CH₃)₃ or not —(CH₂)₅—N(CH₃)₂—(CH₂)₅—N(CH₃)₃. In other embodiments, -Ak-(Z-Ak)ₓ-FG (e.g., at least one or every -Ak-(Z-Ak)ₓ-FG) is not —(CH₂)₅—(N(CH₃)₂—(CH₂)₆)ₓ—N(CH₃)₃ or not —(CH₂)₅—N(CH₃)₂—(CH₂)₆—N(CH₃)₃. In yet other embodiments, -Ak-(Z-Ak)ₓ-FG (e.g., at least one or every -Ak-(Z-Ak)ₓ-FG) is not —(CH₂)₆—(N(CH₃)₂—(CH₂)₆)ₓ—N(CH₃)₃ or not —(CH₂)₆—N(CH₃)₂—(CH₂)₆—N(CH₃)₃. In some embodiments, —NR^{N1}R^{N2}— (e.g., at least one or every —NR^{N1}R^{N2}—) is not —N(CH₃)₂—.

In some embodiments, the compound includes a structure of formula (IIIa)-(IIIc):

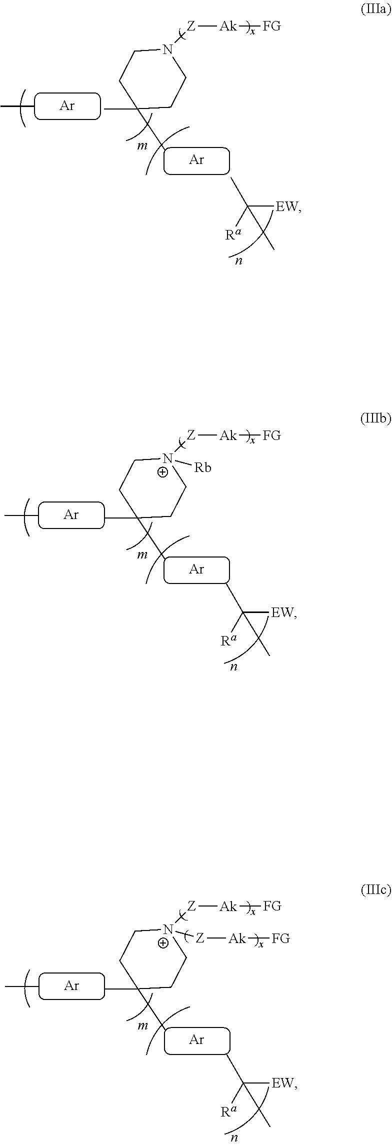

or a salt thereof. In some embodiments, each R^{b} is, independently, H, optionally substituted alkyl, or optionally substituted aryl. In other embodiments, R^{b} is not —CH₃ when R^{a} is unsubstituted phenyl. In particular embodiments, R^{a} is, independently, H or optionally substituted alkyl.

In other embodiments, the compound includes a structure of formula (IVa)-(IVc):

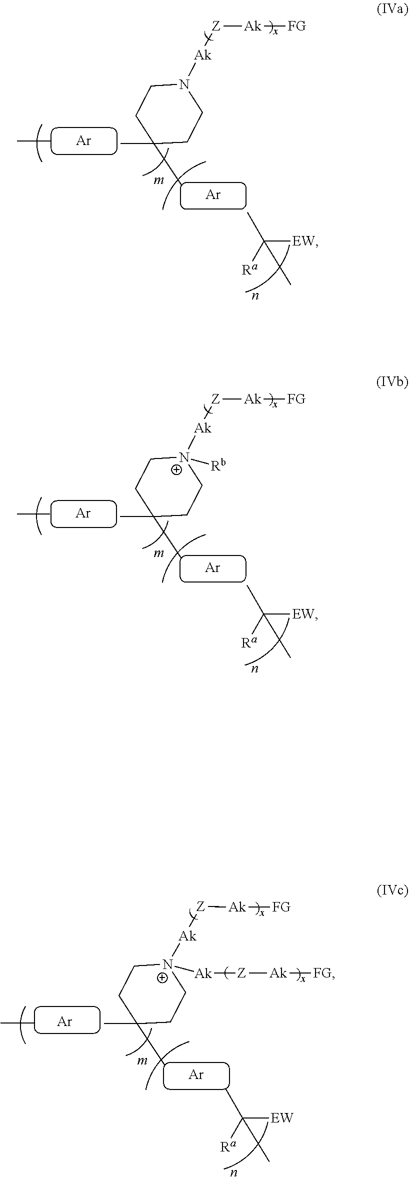

or a salt thereof. In some embodiments, each R^{b} is, independently, H, optionally substituted alkyl, or optionally substituted aryl. In other embodiments, R^{b} is not —CH₃ when R^{a} is unsubstituted phenyl. In particular embodiments, R^{a} is, independently, H or optionally substituted alkyl.

In a second aspect, the present disclosure includes a compound having a structure of formula (Va) or (Vb):

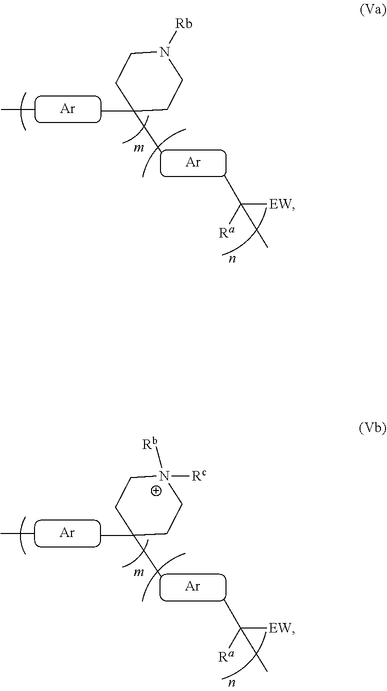

or a salt thereof,

wherein:
each Ar includes, independently, an optionally substituted aromatic or optionally substituted arylene;
each EW is, independently, an electron-withdrawing moiety;
each of R^{a}, R^{b}, and R^{c} is, independently, H, optionally substituted alkyl, or optionally substituted aryl, or optionally wherein R^{b} and R^{c}, taken together, form an optionally substituted alkylene or optionally substituted heteroalkylene; and
each of m and n is, independently, 1 to 1,000,000.

In some embodiments, EW is selected from the group consisting of haloalkyl, optionally substituted heteroaryl, amino, amido, nitrile, and —C(═O)R^{C1}, in which R^{C1} is H, hydroxy, alkoxy, alkyl, or oxygen anion (O⁻).

In particular embodiments, at least one R^{a} is not unsubstituted phenyl. In some embodiments, each of R^{a}, R^{b}, and R^{c} is, independently, H or optionally substituted alkyl. In other embodiments, R^{b} is not —CH₃ when R^{a} is unsubstituted phenyl. In yet other embodiments, R^{a} is, independently, H or optionally substituted alkyl. In particular embodiments, each of R^{b} and R^{c} is, independently, H, optionally substituted alkyl, or optionally substituted aryl; and each of R^{a} is, independently, H or optionally substituted alkyl.

In a third aspect, the present disclosure includes a compound of any described herein (e.g., a compound including a structure of formula (I), (II), (IIa)-(IIe), (IIIa)-(IIIc), (IVa)-(IVc), (Va)-(Vb), or a salt thereof). In some embodiments, the composition includes a polymer, a copolymer, a block copolymer, or a combination thereof. In other embodiments, the composition includes a film or a membrane.

In some embodiments, the composition has an electrolyte uptake of 40% or more; the composition is stable when immersed in 6M KOH at 120° C. for 7 days; the composition has a stress of at least 30 MPa and/or a strain of at least 40% prior to exposure to 6M KOH at 120° C. for 7 days; and/or the composition has a stress of at least 40 MPa and/or a strain of at least 5% after exposure to 6M KOH at 120° C. for 7 days.

In a fourth aspect, the present disclosure includes a method of making a compound of any described herein (e.g., a compound including a structure of formula (I), (II), (IIa)-(IIe), (IIIa)-(IIIc), (IVa)-(IVc), or a salt thereof). In some embodiments, the method includes: reacting an aromatic compound, a first carbonyl agent, and a second carbonyl agent including an electron-withdrawing group in the presence of a strong acid to form a precursor polymer; and reacting the precursor polymer in the presence of a grafting agent to form a polyarylene compound having a hydrophilic graft chain.

In some embodiments, the first carbonyl agent includes an optionally substituted haloalkyl ketone or an optionally substituted piperidinone, wherein the grafting agent includes the —(Z-Ak)ₓ- moiety.

In a fifth aspect, the present disclosure includes a method of making a compound of any described herein (e.g., a compound including a structure of formula (Va)-(Vb) or a salt thereof). In some embodiments, the method includes: reacting an aromatic compound, a first carbonyl agent includes an R^{b}-substituted ketone, and a second carbonyl agent including an electron-withdrawing group in the presence of a strong acid to form a polyarylene compound.

In some embodiments, the first carbonyl agent includes an N-substituted piperidinone, in which the nitrogen atom of the piperidinone is substituted with the R^{b} group.

In any method herein, the method further includes (e.g., after said reacting): exchanging a first anion of the precursor polymer or the polyarylene compound with a second anion, wherein the first and second anions are different.

In any embodiment herein, each Ar is, independently, selected from the group consisting of:

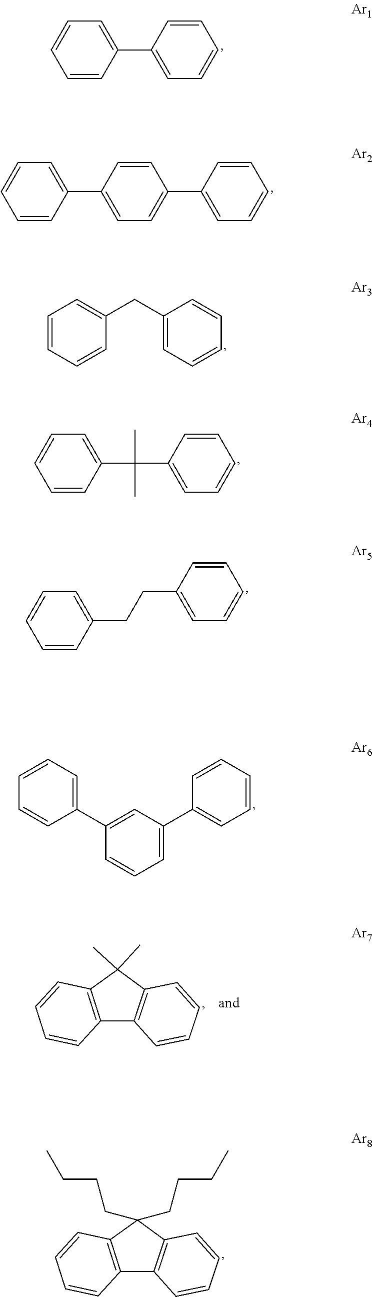

which can be unsubstituted or substituted with one or more suitable substituents.

In any embodiment herein, each EW is, independently, selected from the group consisting of CF₃, pyridine, heterocyclic amino, —C(═O)OH, amido, and nitrile.

In any embodiment herein, each Ak is, independently, optionally substituted C₁₋₆ alkylene (e.g., substituted or unsubstituted C₁₋₆ alkylene), optionally substituted C₁₋₅ alkylene (e.g., substituted or unsubstituted C₁₋₅ alkylene), or optionally substituted C₁₋₄ alkylene (e.g., substituted or unsubstituted C₁₋₄ alkylene).

In any embodiment herein, Z is selected from the group consisting of —O—, —S—, —NH—, and —CH₂—; and/or FG is selected from the group consisting of CH₃, CH₂CH₃, alkyl, aryl, OH, NR^{N1}R^{N2}R^{N3}, SO₃H, P(═O)(OH)₂, CO₂H, NR^{N1}R^{N2}R^{N3} Cl, and NR^{N1}R^{N2}R^{N3} Br, in which each of R^{N1}, R^{N2}, and R^{N3} is, independently, H, optionally substituted alkyl, or optionally substituted aryl.

In any embodiment herein, R^{a} is alkyl, haloalkyl, or substituted aryl.

In any embodiment herein, the salt form of FG includes an anion (e.g., a halide, a hydroxide, a borate, a carbonate, or a sulfate).

In any embodiment herein, the compound is free of ether linkages.

### Definitions

By “alkoxy” is meant —OR, where R is an optionally substituted alkyl group, as described herein. Exemplary alkoxy groups include methoxy, ethoxy, butoxy, trihaloalkoxy, such as trifluoromethoxy, etc. The alkoxy group can be unsubstituted or substituted with one or more suitable substituents, e.g., as described herein. Exemplary unsubstituted alkoxy groups include C₁₋₃, C₁₋₄, C₁₋₆, C₁₋₁₂, C₁₋₁₆, C₁₋₁₈, C₁₋₂₀, or C₁₋₂₄ alkoxy groups.

By “alkyl” is meant a branched or unbranched hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be unsubstituted or substituted with one or more suitable substituents, e.g., as described herein. In some embodiments, the unsubstituted alkyl group is a C₁₋₃, C₁₋₄, C₁₋₆, C₁₋₁₂, C₁₋₁₆, C₁₋₁₈, C₁₋₂₀, or C₁₋₂₄ alkyl group. In particular instances, the alkyl group is a saturated hydrocarbon group. In other instances, the term alkyl also includes “alkenyl,” which is defined as a branched or unbranched unsaturated hydrocarbon group of 2 to 24 carbon atoms, such as ethenyl (or vinyl), 1-propenyl, 2-propenyl, and the like.

By “alkylene” is meant a multivalent (e.g., bivalent, trivalent, tetravalent, etc.) form of an alkyl group, as described herein. Exemplary alkylene groups include methylene, ethylene, propylene, butylene, pentylene, hexylene, etc. In some embodiments, the alkylene group is a C₁₋₃, C₁₋₄, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be unsubstituted or substituted with one or more suitable substituents, e.g., as described herein.

By “amido” is meant a group including —C(O)NR^{N1}R^{N2}, —C(O)NR^{N1}- or —NR^{N1}C(O)—, where each of R^{N1} and R^{N2} is, independently, H, optionally substituted alkyl, or optionally substituted aryl; or R^{N1} and R^{N2}, taken together with the nitrogen atom to which each are attached, form a heterocyclyl group, as defined herein.

By “amino” is meant a group including —NR^{N1}R^{N2} or —NR^{N1}—, where each of R^{N1} and R^{N2} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group, as defined herein; or R^{N1} and R^{N2}, taken together, form an optionally substituted alkylene or heteroalkylene, as described herein.

By “ammonium” is meant a group including a protonated nitrogen atom N⁺. Exemplary ammonium groups include —N⁺R^{N1}R^{N2}R^{N3} where each of R^{N1}, R^{N2}, and R^{N3} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group, as defined herein; or R^{N1} and R^{N2}, taken together, form an optionally substituted alkylene or heteroalkylene (e.g., as described herein); or R^{N1} and R^{N2} and R^{N3}, taken together with the nitrogen atom to which each are attached, form an optionally substituted heterocyclyl group, such as a heterocyclic cation. Non-limiting ammonium groups can include trialkyl ammonium (e.g., —N⁺R^{N1}R^{N2}R^{N3}, in which each of R^{N1}, R^{N2}, and R^{N3} is, independently, optionally substituted alkyl), piperidinium (e.g., —N⁺R^{N1}R^{N2}R^{N3}, in which R^{N3} is, independently, optionally substituted alkyl or optionally substituted aryl, and in which R^{N1} and R^{N2}, taken together with the nitrogen atom to which each are attached, form an optionally substituted piperidinium group), or pyrrolidinium (e.g., —N⁺R^{N1}R^{N2}R^{N3}, in which R^{N3} is, independently, optionally substituted alkyl or optionally substituted aryl, and in which R^{N1} and R^{N2}, taken together with the nitrogen atom to which each are attached, form an optionally substituted pyrrolidinium group).

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system. Such an aromatic can be unsubstituted or substituted with one or more suitable substituents, e.g., as described herein.

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be unsubstituted or substituted with one or more suitable substituents, e.g., as described herein.

By “arylene” is meant a multivalent (e.g., bivalent, trivalent, tetravalent, etc.) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be unsubstituted or substituted with one or more suitable substituents, e.g., as described herein.

By “cycloalkyl” is meant a monovalent saturated or unsaturated non-aromatic cyclic hydrocarbon group of from three to ten carbons (e.g., C₃₋₈ or C₃₋₁₀), unless otherwise specified, and is exemplified by cyclopropyl, cyclobutyl, cyclopentyl, cyclohexyl, cycloheptyl, bicyclo[2.2.1.]heptyl, and the like. The term cycloalkyl also includes “cycloalkenyl,” which is defined as a non-aromatic carbon-based ring composed of three to ten carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The cycloalkyl group can also be unsubstituted or substituted with one or more suitable substituents, e.g., as described herein.

By “halo” is meant F, Cl, Br, or I.

By “haloalkyl” is meant an alkyl group, as defined herein, substituted with one or more halo.

By “heteroalkyl” is meant an alkyl group, as defined herein, containing one, two, three, or four non-carbon heteroatoms (e.g., independently selected from the group consisting of nitrogen, oxygen, phosphorous, or sulfur).

By “heteroalkylene” is meant a bivalent form of an alkylene group, as defined herein, containing one, two, three, or four non-carbon heteroatoms (e.g., independently selected from the group consisting of nitrogen, oxygen, phosphorous, or sulfur). The heteroalkylene group can be unsubstituted or substituted with one or more suitable substituents, as described herein.

By “heteroaryl” is meant a subset of heterocyclyl groups, as defined herein, which are aromatic, i.e., they contain 4n+2 pi electrons within the mono- or multicyclic ring system.

By “heterocyclic amino” is meant a heterocyclyl group, as defined herein, having one, two, three, or four nitrogen atoms. The nitrogen atom can be charged (e.g., having a cationic charge) or uncharged. Non-limiting heterocyclic amino groups included piperidinyl (e.g., piperidin-1-yl, piperidin-4-yl, N-alkyl-piperidin-4-yl, piperidine-4,4′-diyl, N-alkyl-piperidine-4,4′-diyl, etc.), piperidinium (e.g., N-alkyl-piperidinium-1-yl, N,N′-dialkyl-piperidinium-4-yl, N,N′-dialkyl-piperidinium-4,4′-diyl, etc.), pyrrolidinyl (e.g., pyrrolidin-1-yl, pyrrolidin-3-yl, N-alkyl-pyrrolidin-3-yl, pyrrolidine-3,3′-diyl, N-alkyl-pyrrolidine-3,3′-diyl, etc.), pyrrolidinium (e.g., N-alkyl-pyrrolidinium-1-yl, N,N′-dialkyl-pyrrolidinum-3-yl, N,N′-dialkyl-pyrrolidinum-3,3′-diyl, etc.), and spirocyclic amino groups (e.g., 6-azoniaspiro[5.5]undec-3-yl, 6-azoniaspiro[5.5]undecane-3,3′-diyl, 6-azoniaspiro[5.6]dodec-3-yl, 6-azoniaspiro[5.6]dodecane-3,3′-diyl, etc.). The heterocyclic amino group can be unsubstituted or substituted with one or more suitable substituents, as described herein.

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorous, or sulfur). The 3-membered ring has zero to one double bonds, the 4- and 5-membered ring has zero to two double bonds, and the 6- and 7-membered rings have zero to three double bonds. Heterocyclyl groups can be uncharged (neutral) or charged (e.g., cationic or anionic). The term “heterocyclyl” also includes bicyclic, tricyclic, and tetracyclic groups in which any of the above heterocyclic rings is fused to one, two, or three rings. Heterocyclics include benzofuryl, benzimidazolyl, benzothienyl, furyl, imidazolyl, indolyl (e.g., 1H-indolyl or 3H-indolyl), isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pyranyl, pyrazinyl, pyrazolidinyl, pyrazolinyl, pyrazolyl, pyridazinyl, pyridinyl, pyridyl, pyrimidinyl, pyrimidyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinolyl, quinoxalinyl, succinimidyl, tetrahydrofuranyl, tetrahydrofuryl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiophenyl, thiopyranyl, thiopyronyl, thiotriazolyl, thiourazolyl, thioxanyl, thioxolyl, thymidinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be unsubstituted or substituted with one or more suitable substituents, as described herein.

By “nitrile” is meant a —CN group.

Non-limiting suitable substituents include, but are not limited to, aliphatic or haloaliphatic groups, halo groups, nitrate groups, cyano groups, sulfonate groups, sulfonyl groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocyclic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, carbonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium). Yet other salts can include an anion, such as a halide (e.g., F⁻, Cl⁻, Br⁻, or I⁻), a hydroxide (e.g., OH⁻), a borate (e.g., tetrafluoroborate (BF₄⁻), a carbonate (e.g., CO₃²⁻ or HCO₃⁻), or a sulfate (e.g., SO₄²⁻).

By “leaving group” is meant an atom (or a group of atoms) with electron withdrawing ability that can be displaced as a stable species, taking with it the bonding electrons, or an atom (or a group of atoms) that can be replaced by a substitution reaction. Examples of suitable leaving groups include H, halides, and sulfonates including, but not limited to, triflate (—OTf), mesylate (—OMs), tosylate (—OTs), brosylate (—OBs), acetate, Cl, Br, and I.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

### BRIEF DESCRIPTION OF THE DRAWINGS

FIG. 1 shows a schematic of a non-limiting degradation mechanism of an aryl ether bond in the backbone of a poly(sulfone) polymer.

FIG. 2A-2C shows schematics of non-limiting membranes. Provided are (A) a diaphragm material, (B) an anion exchange membrane (AEM), and (C) an anion-solvating polymer membrane. Such membranes can include a solid phase (indicated by wavy lines), an aqueous phase (indicated by white regions), anions (indicated by—within a circle), and cations (indicated by + within a circle). In non-limiting instances, anions can include hydroxide, and cations can include potassium.

FIG. 3 shows non-limiting structures for polymers described herein.

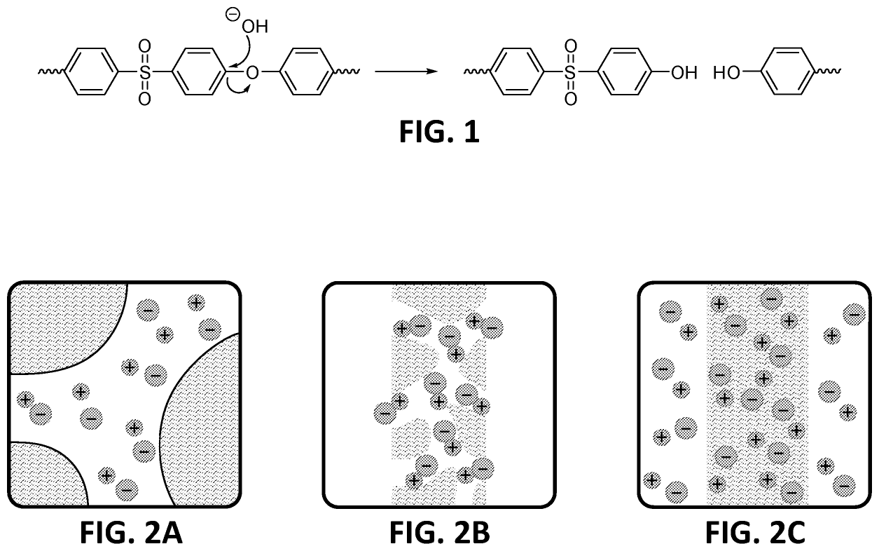

### DETAILED DESCRIPTION

Embodiments of the present technology relate to a series of anion-solvating (e.g., hydroxide-solvating) polymer membranes that are stable in strong alkaline condition (e.g., >6M KOH solution) even at elevated temperature (e.g., >80° C.) for alkaline water electrolyzer.

In one embodiment, the compound includes a structure of formula (I):

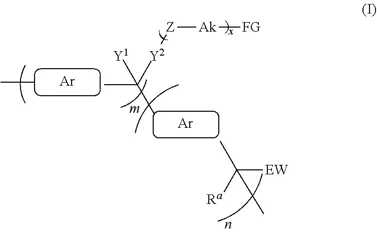

or a salt thereof,

wherein:
each Ar comprises, independently, an optionally substituted aromatic or optionally substituted arylene;
each Y¹ is, independently, EW and each Y² is, independently, Ak; or Y¹ and Y², taken together, comprises an optionally substituted heterocyclic amino;
each Z is, independently, selected from the group consisting of —O—, —S—, —NR^{N1}—, —NR^{N1}R^{N2}—, and —CR^{C2}R^{C3}—, in which each of R^{N1}, R^{N2}, R^{C2}, and R^{C3} is, independently, H, optionally substituted alkyl, or optionally substituted aryl, and in which at least one Z is not —CR^{C2}R^{C3}— or in which at least one Z is not —N(CH₃)₂—;
each Ak is, independently, optionally substituted alkylene;
x is 1 to 20;
each FG is, independently, selected from the group consisting of optionally substituted alkyl, optionally substituted aryl, hydroxy, amino, ammonium cation, sulfo, sulfonate anion, phosphono, phosphonate anion, carboxyl, carboxylate anion, heterocyclic cation, or a salt form thereof;
each EW is, independently, selected from the group consisting of haloalkyl, optionally substituted heteroaryl, amino, amido, nitrile, and —C(═O)R^{C1}, in which R^{C1} is H, hydroxy, alkoxy, alkyl, or oxygen anion (O⁻);
each R^{a} is, independently, H, optionally substituted alkyl, optionally substituted aryl, or optionally substituted heteroaryl;
each of m and n is, independently, 1 to 1,000,000.

In some embodiments, the compound includes a structure of formula (Ia) or (Ib):

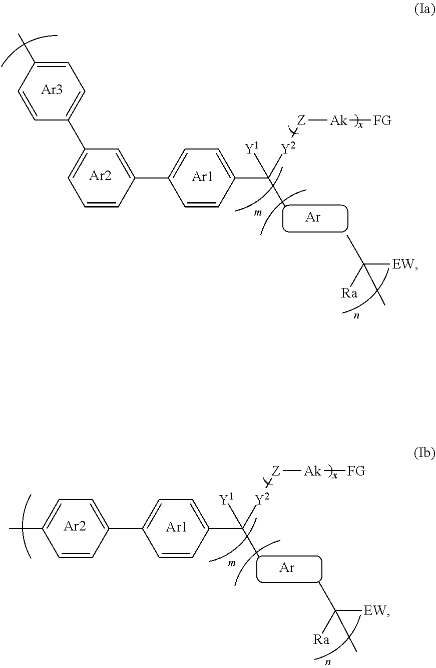

or a salt thereof. In particular embodiments, each of rings Ar1, Ar2, and/or Ar3 can be optionally substituted (e.g., with a suitable substituent, such as any described herein). In other embodiments, Ar includes terphenylene (e.g., meta-terphenylene, ortho-terphenylene, or para-terphenylene) or biphenylene.

In particular embodiments, Z (e.g., at least one Z or each Z) is not —CR^{C2}R^{C3}—. In other embodiments, at least one —Z-Ak- includes one or more heteroatoms (e.g., non-carbon atoms, such as nitrogen, oxygen, sulfur, or phosphorus). In yet other embodiments, Z (e.g., at least one Z or each Z) is not —N(CH₃)₂—.

In particular embodiments, the —Z-Ak- group can be included in a graft chain. This graft chain can be repeated, such as in —(Z-Ak)ₓ-. The type and number of graft chains present on the polymer can be modified. Without wishing to be limited by mechanism, the graft chain can impart hydrophilic moieties to the polymer, thereby allowing for sufficient anion solvation.

The compounds herein can include one or more graft chains. In some embodiments, the graft chain includes a —(Z-Ak)ₓ- group and a functional group (FG), in which Ak is an optionally substituted alkylene, at least one Z includes a heteroatom (e.g., a non-carbon atom), and x is 1 to 20. In other embodiments, the graft chain includes an -Ak-(Z-Ak)ₓ- group and an FG, in which Ak is an optionally substituted alkylene, at least one Z includes a heteroatom (e.g., a non-carbon atom), and x is 1 to 20.

Non-limiting Ak can include optionally substituted C₁₋₂₄, C₂₋₂₄, C₄₋₂₄, C₆₋₂₄, C₁₋₁₂, C₂₋₁₂, C₄₋₁₂, C₆₋₁₂, C₁₋₆, C₁₋₅, or C₁₋₄ alkylene. Z can include one or more heteroatoms, such as nitrogen, oxygen, phosphorous, or sulfur. In particular embodiments, Z includes —O—, —S—, —NR^{N1}—, —NR^{N1}R^{N2}—, and —CR^{C2}R^{C3}—, in which each of R^{N1}, R^{N2}, R^{C2}, and R^{C3} is, independently, H, optionally substituted alkyl, or optionally substituted aryl.

FG can include any useful group. In particular embodiments, FG can be optionally substituted alkyl (e.g., optionally substituted C₁₋₂₄, C₂₋₂₄, C₄₋₂₄, C₆₋₂₄, C₁₋₁₂, C₂₋₁₂, C₄₋₁₂, C₆₋₁₂, or C₁₋₆ alkyl), optionally substituted aryl (e.g., optionally substituted phenyl), hydroxy (—OH), amino (e.g., —NR^{N1}R^{N2}, as described herein), ammonium cation (e.g., —N⁺R^{N1}R^{N2}R^{N3} or —N⁺R^{N1}R^{N2}—, as described herein), sulfo (—SO₂OH), sulfonate anion (—SO₂O⁻), phosphono (e.g., —P(═O)(OH)₂), phosphonate anion (e.g., —P(═O)(O⁻)₂ or —P(═O)(OH)(O⁻), carboxyl (—CO₂H), carboxylate anion (—CO₂⁻), heterocyclic cation, or a salt form thereof. Non-limiting examples of heterocyclic cations include optionally substituted piperidinium, optionally substituted pyrrolidinium, optionally substituted azepanium, or optionally substituted spirocyclic amino groups having a cationic nitrogen atom (e.g., any described herein).

The compounds herein can include one or more arylene linkers, which can be indicated as Ar. Ar can include an optionally substituted arylene. Such arylene groups include any multivalent (e.g., bivalent, trivalent, tetravalent, etc., in the ortho, para, or meta positions) groups having one or more aromatic groups, which can include heteroaromatic groups. Non-limiting aromatic groups can include any of the following:

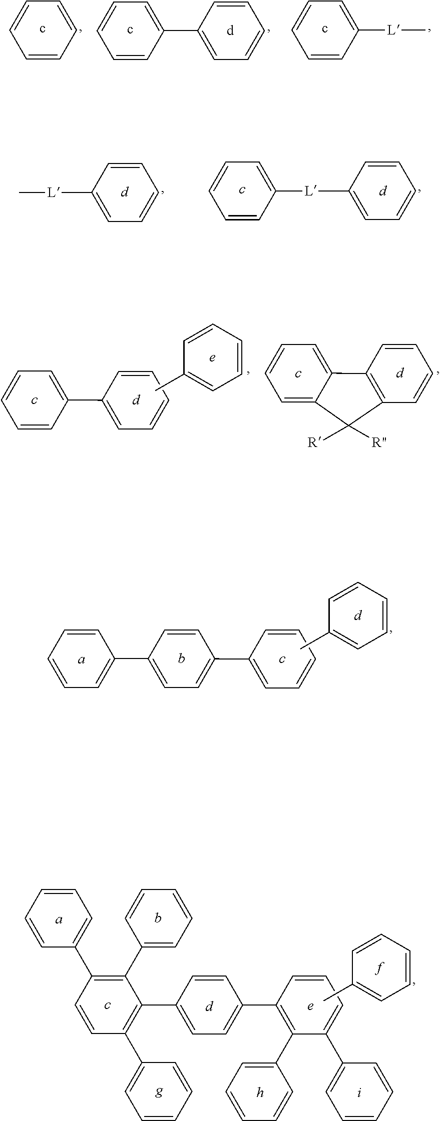

in which each of rings a-i can be optionally substituted (e.g., with any optional substituents described herein; or with any ionic moiety described herein); L′ is a linking moiety (e.g., any described herein, such as a covalent bond or C₁₋₆ alkylene); and each of R′ and R″ is, independently, H or optionally substituted alkyl. Non-limiting substituents for rings a-i include one or more described herein (e.g., such as a suitable substituent) and include, but are not limited to, alkyl, alkoxy, alkoxyalkyl, amino, aminoalkyl, aryl, arylalkylene, aryloyl, aryloxy, arylalkoxy, cyano (or nitrile), hydroxy, hydroxyalkyl, nitro, halo, and haloalkyl. In some embodiments, L′ is a covalent bond, —O—, —NR^{N1}— (in which R^{N1} can be H, optionally substituted alkyl, or optionally substituted aryl), —C(O)—, optionally substituted alkylene, optionally substituted heteroalkylene, or optionally substituted arylene.

Yet other non-limiting arylene can include phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene, 4,4′-meta-terphenylene, 4,4′-para-terphenylene, or 4,4′-ortho-terphenylene), 9,10-anthracene, naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like. Other examples of arylene include the following:

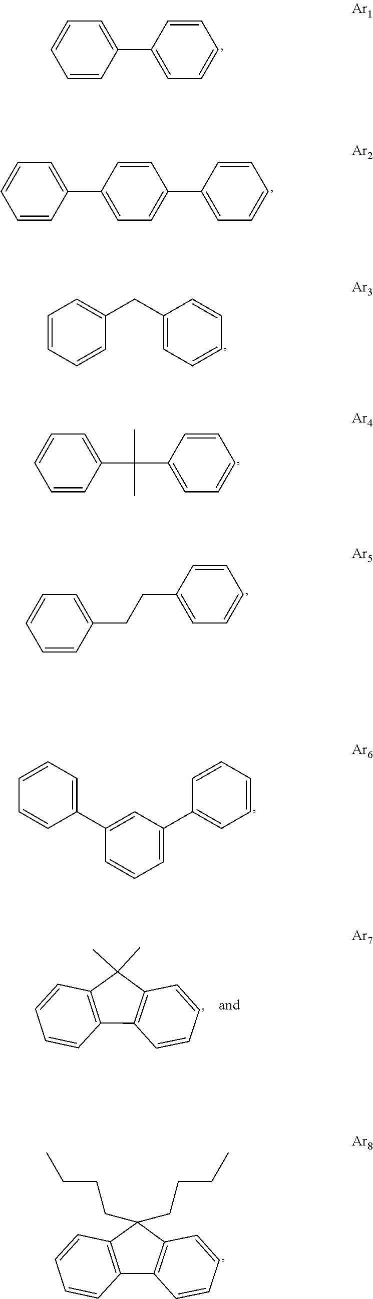

which can be unsubstituted or substituted with one or more suitable substituents, e.g., as described herein.

In some embodiments, each arylene linker is attached to a substituted alpha carbon. This alpha carbon, in turn, can be in proximity to an electron-withdrawing moiety. Thus, in one instance, the alpha carbon can be or include:

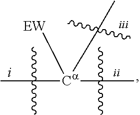

in which EW is an electron-withdrawing group, as described herein; each of bonds i and ii is attached to an Ar group; and bond iii is attached, directly or indirectly (e.g., by way of a linker, such as an alkylene linker), to the —Z-Ak- group. In another instance, the alpha carbon can be or include:

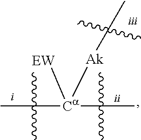

in which each of bonds i and ii is attached to an Ar group; and bond iii is attached, directly or indirectly to the —Z-Ak- group.

In yet another instance, the alpha carbon can be or include:

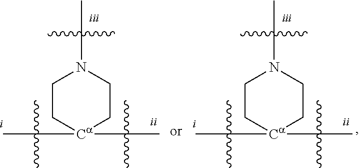

in which each of bonds i and ii is attached to an Ar group; and each of bonds iii and iv is attached, directly or indirectly (e.g., by way of a linker, such as an alkylene linker), to the —Z-Ak- group, the R^{b} group, or the R^{c} group, as described herein. In particular embodiments, R_{b} is not —CH₃. In other embodiments, R_{c} is not —CH₃. In yet other embodiments, neither R_{b} nor R_{c} is —CH₃.

Electron-withdrawing groups can be present within the polymer. Without wishing to be limited by mechanism, the presence of such groups can facilitate polycondensation reactions between monomers. Non-limiting reactions can include an acid-catalyzed Friedel-Crafts reaction, as further described below. In some embodiments, the electron-withdrawing group is indicated by EW. Non-limiting EW groups include, e.g., optionally substituted haloalkyl (e.g., perfluoroalkyl), optionally substituted heteroaryl (e.g., optionally substituted piperidinium or optionally substituted pyridine), an amino (e.g., a heterocyclic amino, such as optionally substituted piperidinyl; a group including —NR^{N1}R^{N2} or —NR^{N1}—; as well as others described herein), amido (e.g., a group including —C(O)NR^{N1}R^{N2}, —C(O)NR^{N1}—, or —NR^{N1}C(O)—, as described herein), nitrile (—CN), and a carbonyl-containing group, such as —C(═O)R^{C1}, in which R^{C1} is H, hydroxy, alkoxy, alkyl, or oxygen anion (O⁻) or a group including —C(O)—. In particular embodiments, EW is a haloalkyl (e.g., a C₁₋₁₂, C₁₋₆, or C₁₋₃ haloalkyl) or a perfluoroalkyl (e.g., a C₁₋₁₂, C₁₋₆, or C₁₋₃ perfluoroalkyl).

Yet other compounds can include formulas (II), (IIa)-(IIe), (III), (IIIa)-(IIIc), (IVa)-(IVb), (Va), (Vb), or a salt thereof. In any of these formulas, each R^{a} is, independently, H or optionally substituted alkyl. In other embodiments, R^{a} (e.g., at least one R^{a} or each R^{a}) is not unsubstituted phenyl. In yet other embodiments, R^{a} (e.g., at least one R^{a} or each R^{a}) is not optionally substituted phenyl or not optionally substituted aryl.

Each of formulas (II), (IIa)-(IIe), (III), (IIIa)-(IIIc), and (IVa)-(IVb) includes at least one graft chain, such as —(Z-Ak)ₓ-FG, -Ak-(Z-Ak)ₓ-FG, or —C₆ alkylene-(Z—C₆ alkylene)ₓ-FG. For these formulas, each Y¹ can be, independently, EW; and each Y² can be, independently, Ak (e.g., as in formulas (II) and (IIa)-(IIe)).

In other formulas, Y¹ and Y², taken together, can include an optionally substituted heterocyclic amino (e.g., optionally substituted piperidinyl, optionally substituted piperidinium, optionally substituted pyrrolidinyl, optionally substituted pyrrolidinium, as well as spirocyclic forms thereof). Non-limiting formulas having an optionally substituted heterocyclic amino includes those in formulas (IIIa)-(IIIc) and (IVa)-(IVc).

Formulas (Va) and (Vb) includes R^{b} or R^{c}, which can be H, optionally substituted alkyl, or optionally substituted aryl. In particular embodiments (e.g., of formulas (Va) and (Vb)), R^{b} and/or R^{c} is not —CH₃ (e.g., when R^{a} is unsubstituted phenyl). In other embodiments (e.g., of formulas (IIIb), (IVb), (Va), and (Vb)), R^{b} is not —CH₃ (e.g., when R^{a} is unsubstituted phenyl). In yet other embodiments (e.g., of formulas (IIIb), (IVb), (Va), and (Vb)), each of R^{b} and R^{c} is, independently, H, optionally substituted alkyl, or optionally substituted aryl, and each R^{a} is, independently, H or optionally substituted alkyl.

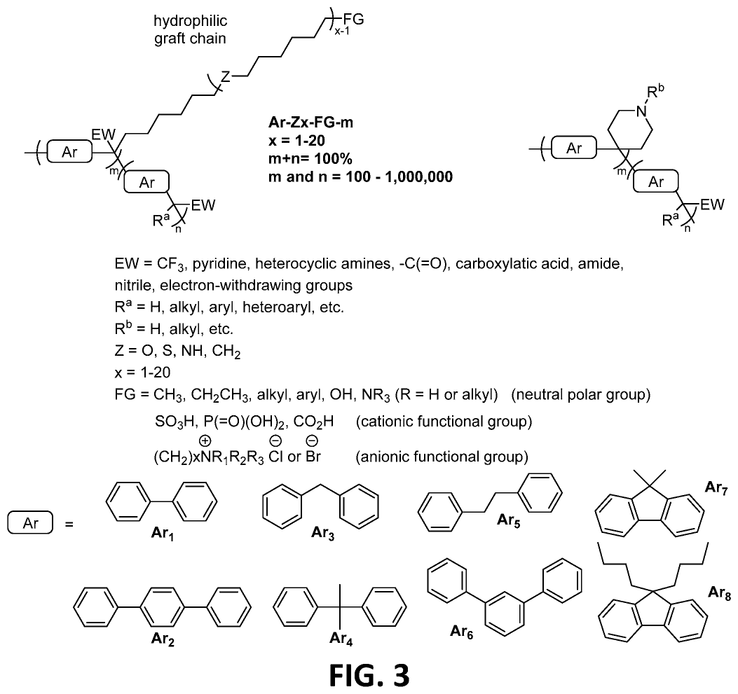

FIG. 3 shows further non-limiting general structures for a polymer. In some embodiments, the polymer backbone is composed of only carbon-carbon bonds, and it does not include labile heteroatoms, providing high chemical stability under alkaline conditions. Moreover, the glass transition temperature (T_{g}) of those aromatic backbone polymers is higher than 200° C. The high alkaline stability and good thermal property provides desirable chemical stability under high pH and high temperature conditions in alkaline water electrolyzers at a temperature of 80-140° C.

In some embodiments, polymers that are stable in KOH are generally hydrophobic and cannot be doped with KOH. Thus, hydrophilic moieties are attached to the sidechain to promote swelling electrolyte uptake in some embodiments. With this type of chemical modification, an electrolyte concentration of 10-30% KOH (aq.) and an uptake of 50% is possible to afford a high ion conductivity. As shown in Table 1, mTPSA and mTPOH which includes sulfonate and hydroxide groups, respectively, shows excellent alkaline stability in 6M KOH solution at 120-140° C. Alkaline stability can be determined by a minimal change to IEC (e.g., a loss of less than about 1%, 1.5%, 2%, 3%, or 5% after an alkaline stability test).

TABLE 1
Representative alkaline stability of
hydroxide-solvating polymer membranes

| | | Name | | | | |
|---|---|---|---|---|---|---|
| Structure | | mTPM | | mTPSA | mTPOH | |
| Alkaline | KOH_{(aq)} (M) | 6 | 6 | 6 | 6 | 6 |
| Stability | Temp. (° C.) | 120 | 140 | 120 | 120 | 140 |
| Test | Time (days) | 7 | 7 | 7 | 7 | 7 |
| ¹H NMR (after stability | | No | No | No | No | No |
| test) | | change | change | change | change | change |
| GPC (after stability | | | No | | | |
| test) | | | change | | | |
| FTIR (after stability | | | | | | No |
| test) | | | | | | change |
| Before | Stress | 53 MPa | 53 MPa | 35 MPa | 45 MPa | 45 MPa |
| Stability | Strain | 44% | 44% | 109% | 81% | 81% |
| Test | | | | | | |
| After | Stress | 63 MPa | 60 MPa | 47 MPa | 62 MPa | 66 MPa |
| Stability | Strain | 7.2% | 6.1% | 44% | 24% | 7.7% |
| Test | | | | | | |

| | | | | | |
|---|---|---|---|---|---|
| Solubility (after stability | Soluble | Soluble | Soluble | Less | Less |
| test) | | | | soluble | soluble |

In some embodiments, the compound does not include the following:

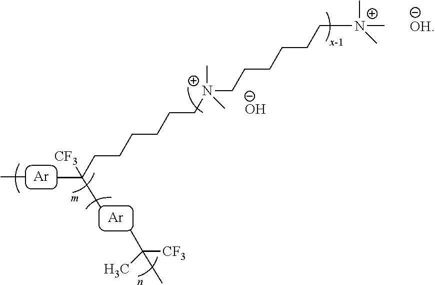

In other embodiments, at least one Z is not
—N(CH₃)₂—. In yet other embodiments, every Z is not —N(CH₃)₂—. In some embodiments, the compound does not include:

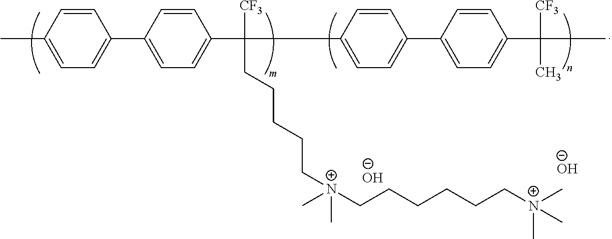

In some embodiments, at least one Z in —(Z-Ak)ₓ-FG is not —N(CH₃)₂—. In other embodiments, Z in —(Z-Ak)ₓ-FG is not —N(CH₃)₂—. In some embodiments, at least one Ak in

—(Z-Ak)ₓ-FG is not unsubstituted C₆ alkylene (e.g., —(CH₂)₆—) and/or not unsubstituted C₅ alkylene (e.g., —(CH₂)₅—). In other embodiments, Ak in —(Z-Ak)ₓ-FG is not unsubstituted C₆ alkylene (e.g., —(CH₂)₆—) and/or not unsubstituted C₅ alkylene (e.g., —(CH₂)₅—). In some embodiments, at least one FG in —(Z-Ak)ₓ-FG is not —N(CH₃)₃. In other embodiments, FG in
—(Z-Ak)ₓ-FG is not —N(CH₃)₃. In some embodiments, at least one Ak that attaches —(Z-Ak)ₓ-FG to the parent molecular group (e.g., at least one -Ak- located between the alpha carbon in formula (I) and the —(Z-Ak)ₓ-FG chain) is not unsubstituted C₆ alkylene (e.g., —(CH₂)₆—) and/or not unsubstituted C₅ alkylene (e.g., —(CH₂)₅—). In other embodiments, the Ak that attaches —(Z-Ak)ₓ-FG to the parent molecular group is not unsubstituted C₆ alkylene (e.g., —(CH₂)₆—) and/or not unsubstituted C₅ alkylene (e.g., —(CH₂)₅—).

In particular embodiments, at least one —(Z-Ak)ₓ-FG is not —(N(CH₃)₂—(CH₂)₅)ₓ—N(CH₃)₃ or not —N(CH₃)₂—(CH₂)₅—N(CH₃)₃. In other embodiments, at least one —(Z-Ak)ₓ-FG is not —(N(CH₃)₂—(CH₂)₆)ₓ—N(CH₃)₃ or not —N(CH₃)₂—(CH₂)₆—N(CH₃)₃.

In some embodiments, at least one -Ak-(Z-Ak)ₓ-FG is not —(CH₂)₅—(N(CH₃)₂—(CH₂)₅)ₓ—N(CH₃)₃ or not —(CH₂)₅—N(CH₃)₂—(CH₂)₅—N(CH₃)₃. In other embodiments, at least one -Ak-(Z-Ak)ₓ-FG is not —(CH₂)₅—(N(CH₃)₂—(CH₂)₆)ₓ—N(CH₃)₃ or not —(CH₂)₅—N(CH₃)₂—(CH₂)₆—N(CH₃)₃. In yet other embodiments, at least one -Ak-(Z-Ak)ₓ-FG is not —(CH₂)₆—(N(CH₃)₂—(CH₂)₆)ₓ—N(CH₃)₃ or not —(CH₂)₆—N(CH₃)₂—(CH₂)₆—N(CH₃)₃.

Although polyphenylene-type materials are shown as representative embodiments in FIG. 3, other embodiments incorporate such hydrophilic moieties to styrene/ethylene/butylene copolymers. Furthermore, hydrophilic additives such as ceramics (e.g., ZrO₂) or hydrophilic polymer (e.g., polyethylene oxide) are inserted to the polymer membrane to enhance hydrophilicity and electrolyte uptake in other embodiments.

In particular embodiments, the compounds or compositions is or includes a polymer, a copolymer, a block copolymer, or a combination thereof. Any useful form can be employed, such as a film or a membrane.

The compounds or compositions herein can be characterized in any useful manner. In one instance, the backbone is free of ether linkages. In another instance, the composition has an electrolyte uptake of 30%, 40%, 50%, or more. In yet another instance, the composition is stable (as evidenced by no change in the ¹H NMR spectra and/or a minimal changes of ionic exchange capacity, IEC) when immersed in 6M KOH at 120° C. for 7 days. In other instances, the composition has a stress of at least 30 MPa and/or a strain of at least 40% prior to exposure to 6M KOH at 120° C. for 7 days; and/or the composition has a stress of at least 40 MPa and/or a strain of at least 5% after exposure to 6M KOH at 120° C. for 7 days. In some instances, the compound or composition is characterized by water uptake of about 20% to 60% (e.g., at 25° C.); swelling in water of about 5% to 35% (at 25° C., in which water can include the hydroxyl form); a hydroxide conductivity of about 100 to 200 mS/cm at 80° C.; and/or an IEC loss of about 0.5% to 3% after an alkaline stability test (e.g., 1M KOH at 80° C. for 1000 hours).

Although the invention has been described and illustrated with respect to exemplary embodiments thereof, it should be understood by those skilled in the art that the foregoing and various other changes, omissions and additions may be made therein and thereto, without parting from the spirit and scope of the present invention.

### Methods of Making

The present disclosure also encompasses methods of making a polymer. A non-limiting method includes reacting an aromatic compound, a first carbonyl agent, and a second carbonyl agent in the presence of a strong acid to form a precursor polymer; and reacting the precursor polymer in the presence of a grafting agent to form a polyarylene compound having a graft chain (e.g., a hydrophilic graft chain). A further step can include exchanging a first anion present in the polymer with second anion (e.g., exchanging a halide anion for a hydroxide anion).

In particular embodiments, the method includes use of an acid-catalyzed Friedel-Crafts polycondensation reaction between monomers, such as the aromatic compound, the first carbonyl agent, and the second carbonyl agent. In particular embodiments, the second carbonyl agent includes an electron-withdrawing group (e.g., a haloalkyl group or others described herein). In yet other embodiments, the first carbonyl agent can also include an electron-withdrawing group, which can be the same or different as that in the second carbonyl agent.

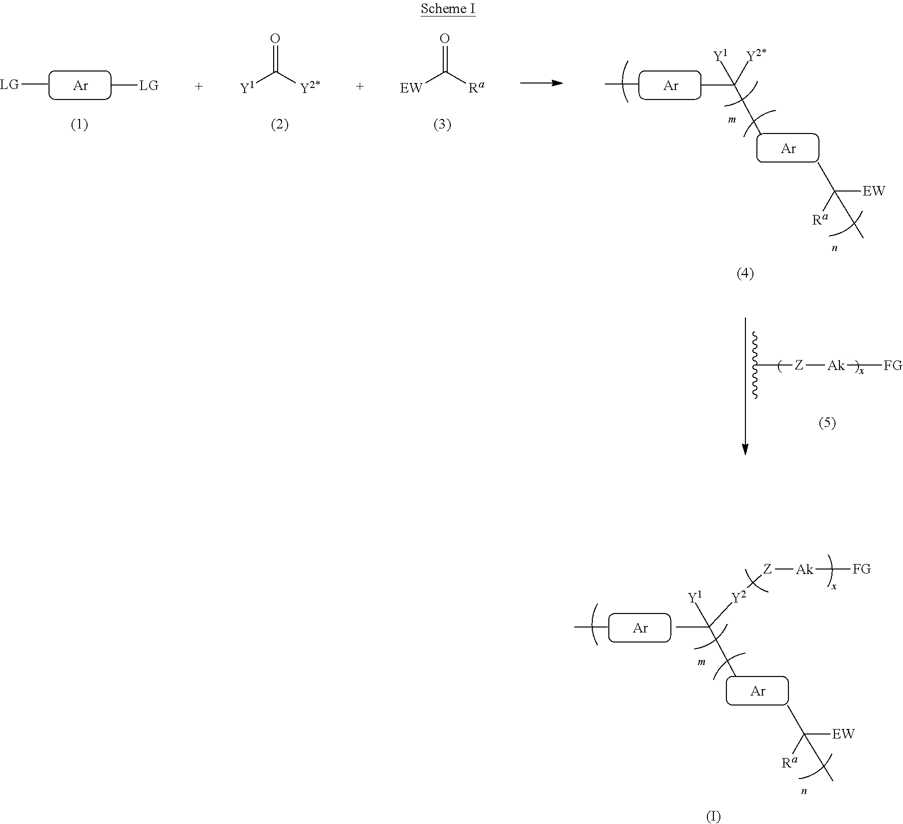

Scheme I provides a non-limiting reaction scheme for making a polymer. The reaction can proceed by providing an aromatic agent (1), which includes an optionally substituted arylene (—Ar—) and leaving groups (LG, e.g., H). Provided is a first carbonyl agent (2), which includes Y¹ and Y²* groups attached to an alpha carbon of the carbonyl group. The Y²* group can include any functional group that, after reaction, provides a Y² group. Also provided is a second carbonyl agent (3), which includes an electron-withdrawing group (EW) and another group (R^{a}, which can be H, alkyl, aryl, or heteroaryl, which can be unsubstituted or substituted).

A Friedel-Crafts polycondensation reaction is performed between these monomers, i.e., agents (1), (2), and (3), in the presence of an acid (e.g., a strong acid) and a solvent, to form a non-limiting precursor polymer (4). Non-limiting acids include trifluoromethanesulfonic acid, pentafluoroethanesulfonic acid, heptafluoro-1-propanesulfonic acid, trifluoroacetic acid, perfluoropropionic acid, heptafluorobutyric acid, or a combination thereof; and non-limiting solvents include polar aprotic solvents (e.g., dimethyl sulfoxide, 1-methyl-2-pyrrolidinone, 1-methyl-2-pyrrolidone, or dimethylformamide) or other suitable organic solvents including, but are not limited to, methylene chloride, trifluoroacetic acid, trifluoromethanesulfonic acid, chloroform, 1,1,2,2-tetrachloroethane, dimethylacetamide, or a combination thereof.

As can be seen, the alpha carbons present in the first and second carbonyl agents (2,3) form a portion of the backbone of the precursor polymer (4). In particular non-limiting embodiments, the backbone of the polymer includes only carbon atoms. In other embodiments, backbone is formed of the aryl groups present in each Ar with the alpha carbon of the first and second carbonyl agents, thereby providing a backbone including all carbon atoms. Optional suitable substituents used to substitute groups in Ar and the alpha carbons of the carbonyl agents can include heteroatoms, while still maintaining a backbone including all carbon atoms.

A grafting agent can be used to introduce a graft chain to the precursor polymer. As seen in Scheme I, the grafting agent can include a graft chain group (5), which can react with the Y²* group. In one instance, the Y²* group can include a nucleophile (e.g., amino), and the grafting agent can include a leaving group (e.g., halo). Such a non-limiting grafting agent can include LG-(Z-Ak)ₓ-FG, in which LG is the leaving group. In another instance, the Y²* group can include a leaving group (e.g., halo), and the grafting agent can include a nucleophile (e.g., amino). Such a non-limiting grafting agent can include Z*-Ak-(Z-Ak)ₓ_-FG, in which Z* includes a nucleophilic group that, after reaction, provides a —Z— group. While FG is provided as a portion of the grafting agent in this non-limiting example, the grafting agent can also include a group that can converted into the FG moiety. For instance, if a desired FG is the ammonium cation, then the grafting agent can have an amino moiety that can be modified into the desired ammonium cation (e.g., by use of an N-alkylating agent). In another instance, if a desired FG is the carboxylate anion, then the grafting agent can have a carboxyl moiety that can be modified into the desired carboxylate anion (e.g., by use of a deprotonation agent). A person skilled in the art would understand how to perform and design such modification.

After grafting, the resulting polyarylene compound can include a compound of formula (I) or a salt thereof. Further reactions can include exchanging a first anion of the precursor polymer or the polyarylene compound with a second anion, wherein the first and second anions are different.

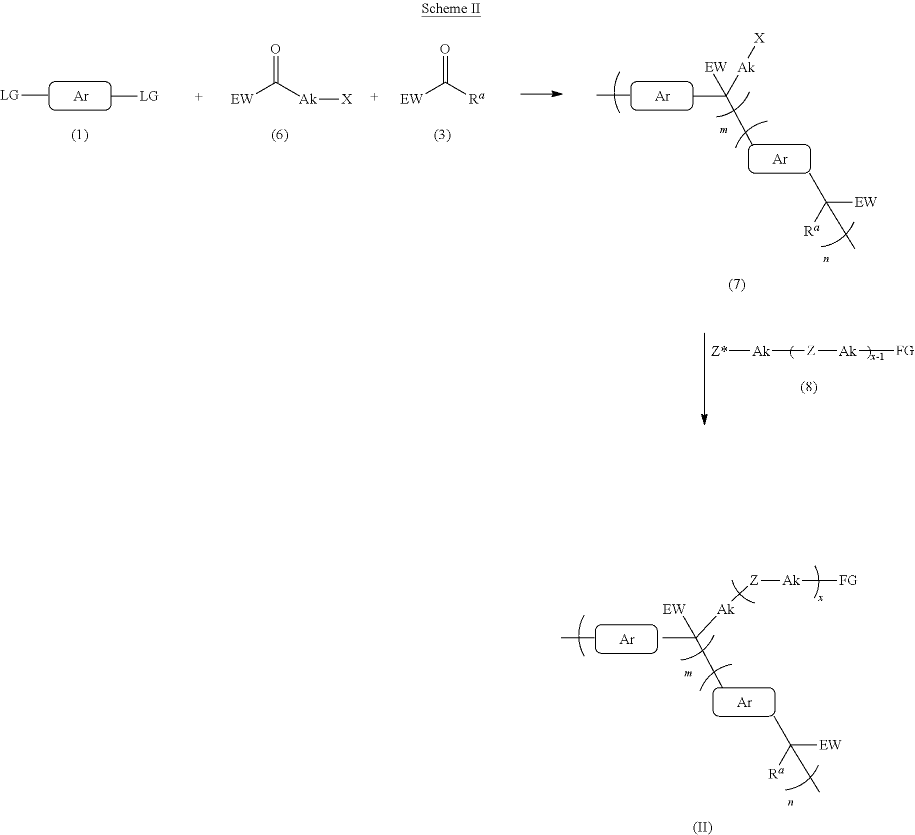

In some instances, both the first and second carbonyl agents can include an electron-withdrawing group, as seen in Scheme II. The reaction can proceed by providing an aromatic agent (1) and a second carbonyl agent (3), as described above with reference to Scheme I. Here, the first carbonyl agent (6) includes a haloalkyl ketone having an EW group and a haloalkyl group (e.g., -Ak-X, in which Ak is an optionally substituted alkylene and X is halo, such as Br). In this ketone, the carbon in the carbonyl group serves as the alpha carbon for the polymer. For first and second carbonyl agents (6,3), the EW group may be the same or different.

A Friedel-Crafts polycondensation reaction is performed between these monomers, i.e., agents (1), (6), and (3), in the presence of an acid (e.g., a strong acid, any described herein) and a solvent (e.g., any described herein), to form a non-limiting precursor polymer (7). As can be seen, the alpha carbons present in the first and second carbonyl agents (6,3) form a portion of the backbone of the precursor polymer (7).

A grafting agent can be used to introduce the graft chain to the precursor polymer. As seen in Scheme II, the precursor polymer includes a leaving group (X), which can react with a grafting agent having a nucleophile. Such a non-limiting grafting agent (8) can include Z*-Ak-(Z-Ak)ₓ₋₁-FG, in which Z* includes a nucleophilic group that, after reaction, provides a —Z— group. After grafting, the resulting polyarylene compound can include a compound of formula (II) or a salt thereof. Further reactions 5 can include exchanging a first anion of the precursor polymer or the polyarylene compound with a second anion, wherein the first and second anions are different.

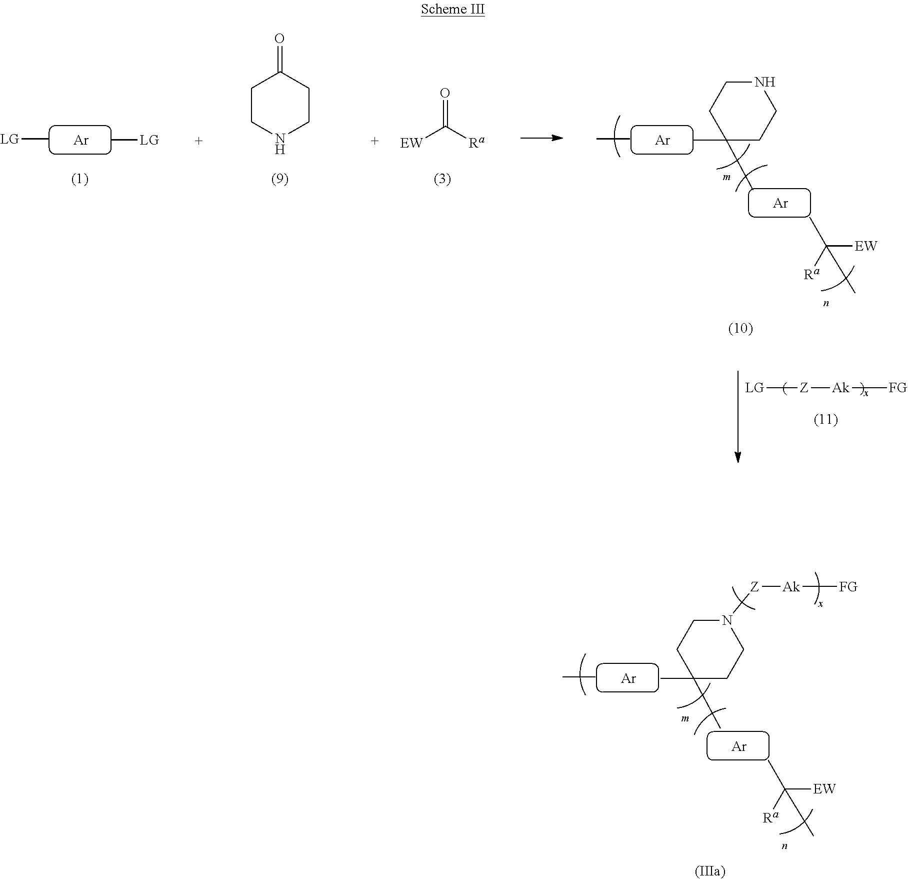

In some instances, the first carbonyl agent can be a cyclic amine, as seen in Scheme III. The reaction can proceed by providing an aromatic agent (1) and a second carbonyl agent (3), as described above with reference to Scheme I. Here, the first carbonyl agent (9) includes a piperidinone (e.g., a 4-piperidinone), in which the carbon in the carbonyl group serves as the alpha carbon for the polymer.

A Friedel-Crafts polycondensation reaction is performed between these monomers, i.e., agents (1), (9), and (3), in the presence of an acid (e.g., a strong acid, any described herein) and a solvent (e.g., any described herein), to form a non-limiting precursor polymer (10). As can be seen, the alpha carbon present in the first carbonyl agent (9) and second carbonyl agent (3) form a portion of the backbone of the precursor polymer (10).

A grafting agent can be used to introduce the graft chain to the precursor polymer. As seen in Scheme III, the precursor polymer includes a nucleophilic group (—NH—), which can react with a grafting agent having a leaving group. Such a non-limiting grafting agent (11) can include LG-(Z-Ak)ₓ-FG, in which LG is a leaving group. After grafting, the resulting polyarylene compound can include a compound of formula (IIIa) or a salt thereof. Further reactions can include exchanging a first anion of the precursor polymer or the polyarylene compound with a second anion, wherein the first and second anions are different.

Other first carbonyl agents can be employed, such as an N-substituted piperidinone, in which the nitrogen atom of the piperidinone is substituted with the R^{b} group. In this instance, reaction with an R^{b}-substituted piperidinone can provide a compound having the structure of formula (IIIb), in which the heterocyclic amine is a heterocyclic cationic amine. In another instance, the reaction of Scheme III can be conducted to provide two hydrophilic graft chains on the nitrogen, thereby providing a compound having the structure of formula (IIIc), in which the heterocyclic amine is a heterocyclic cationic amine.

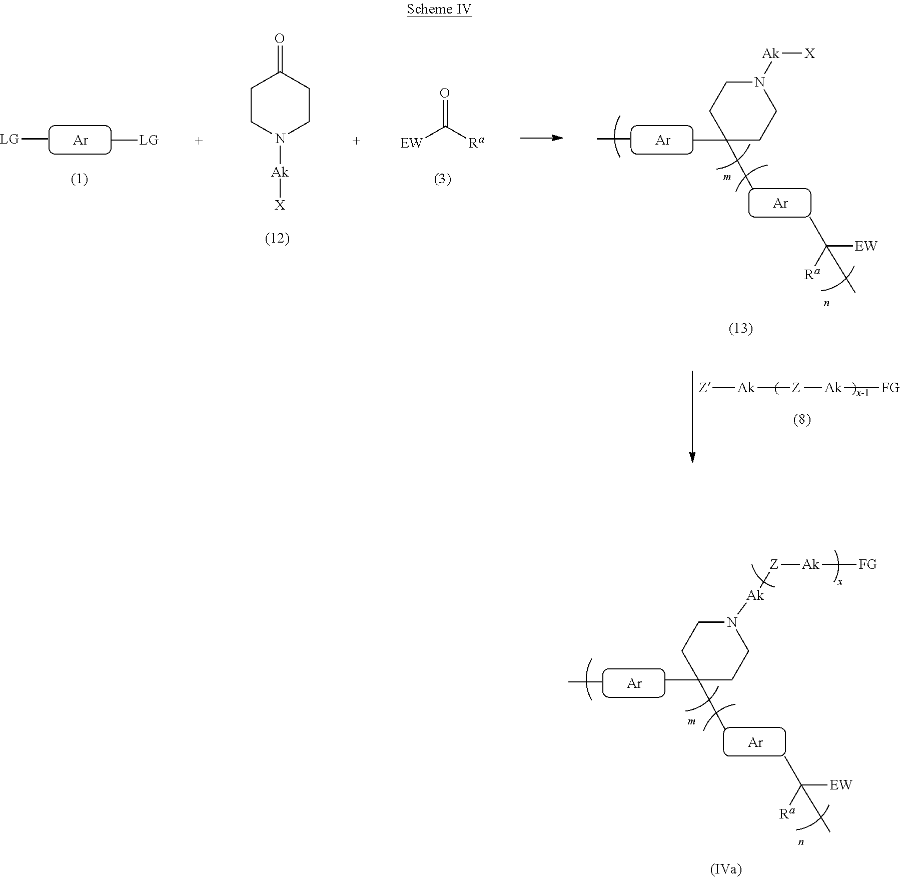

Scheme IV provides use of a substituted piperidinone. The reaction can proceed by providing an aromatic agent (1) and a second carbonyl agent (3), as described above with reference to Scheme I. Here, the first carbonyl agent (12) includes a substituted piperidinone (e.g., an N-substituted 4-piperidinone), in which the carbon atom in the carbonyl group serves as the alpha carbon for the polymer and in which the nitrogen atom is substituted with a haloalkyl group (e.g., -Ak-X, in which Ak is an optionally substituted alkylene and X is halo).

A Friedel-Crafts polycondensation reaction is performed between these monomers, i.e., agents (1), (12), and (3), in the presence of an acid (e.g., a strong acid, any described herein) and a solvent (e.g., any described herein), to form a non-limiting precursor polymer (13). As can be seen, the alpha carbon present in the first carbonyl agent (12) and second carbonyl agent (3) form a portion of the backbone of the precursor polymer (13).

A grafting agent can be used to introduce the graft chain to the precursor polymer. As seen in Scheme IV, the precursor polymer includes a leaving group (X), which can react with a grafting agent having a nucleophile. Such a non-limiting grafting agent (8) can include Z*-Ak-(Z-Ak)ₓ_-FG, as described above. After grafting, the resulting polyarylene compound can include a compound of formula (IVa) or a salt thereof. Further reactions can include exchanging a first anion of the precursor polymer or the polyarylene compound with a second anion, wherein the first and second anions are different.

With respect to Scheme IV, other first carbonyl agents can be employed, such as an N-substituted piperidinone, in which the nitrogen atom of the piperidinone is substituted with the R^{b} group. In this instance, reaction with an R^{b}-substituted piperidinone can provide a compound having the structure of formula (IVb), in which the heterocyclic amine is a heterocyclic cationic amine. In another instance, the reaction of Scheme IV can be conducted with a piperidinone compound substituted with two -Ak-X groups on the nitrogen. Upon reaction, the two -Ak-X groups can each react to provide two hydrophilic graft chains on the nitrogen, thereby providing a compound having the structure of formula (IVc), in which the heterocyclic amine is a heterocyclic cationic amine.

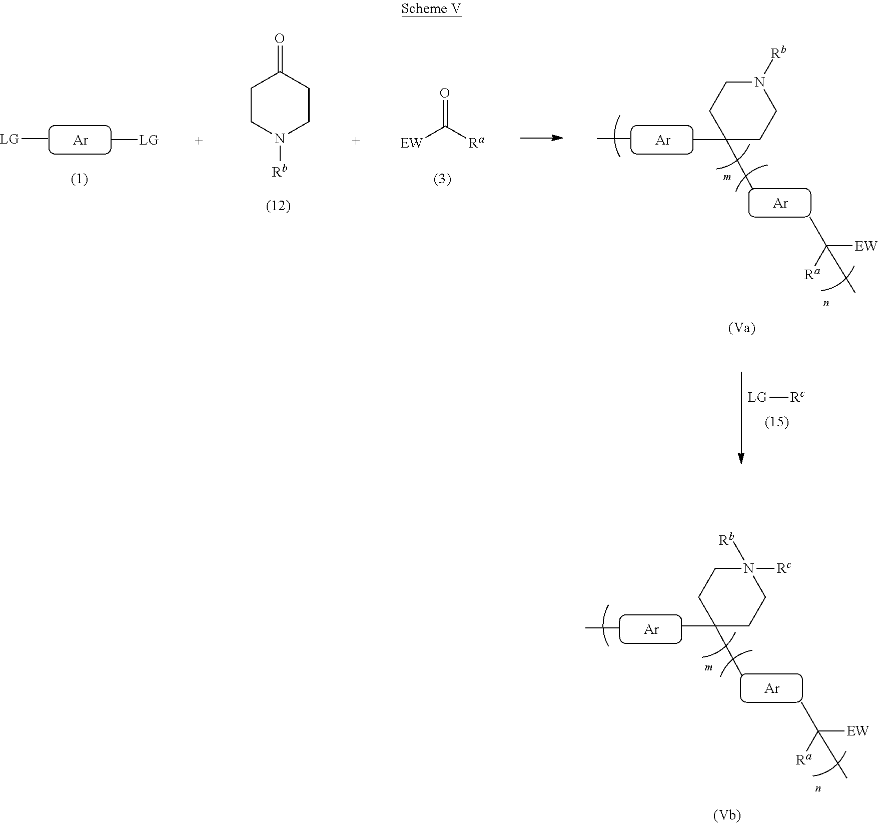

Scheme V provides another use of a substituted piperidinone. The reaction can proceed by providing an aromatic agent (1) and a second carbonyl agent (3), as described above with reference to Scheme I. Here, the first carbonyl agent (14) includes a substituted piperidinone (e.g., an N-substituted 4-piperidinone), in which the carbon atom in the carbonyl group serves as the alpha carbon for the polymer and in which the nitrogen atom is substituted with a R^{b} group (e.g., in which R^{b} can be H or optionally substituted alkyl).

A Friedel-Crafts polycondensation reaction is performed between these monomers, i.e., agents (1), (14), and (3), in the presence of an acid (e.g., a strong acid, any described herein) and a solvent (e.g., any described herein), to form a non-limiting polyarylene compound of formula (V). As can be seen, the alpha carbon present in the first carbonyl agent (14) and second carbonyl agent (3) form a portion of the backbone of the polyarylene compound of formula (Va). Further reactions can include exchanging a first anion of the polyarylene compound with a second anion, wherein the first and second anions are different. Optionally, the polyarylene compound of formula (Va) can be further treated with an alkylation or arylation agent (15) to provide the polyarylene compound of formula (Vb). Alternatively, the first carbonyl agent can include both R^{b} and R^{c} substituted groups on the nitrogen atom, thereby providing the heterocyclic cationic amine present in formula (Vb).

The polymers herein can be used in any useful composition. Such compositions can include layers or membranes, as well as reinforced membranes. A layer or a membrane can be formed in any useful manner. In one embodiment, a compound (e.g., of formula (I) or any described herein) can be dissolved in a solvent to from a casting solution. The casting solution can be optionally filtered, applied to a substrate, and then dried to form a film. Application to a substrate can include doctor blade coating, solution casting, spraying, dip coating, spin coating, extrusion, melt casting, or a combination of any technique. The film can be optionally further treated, such as by immersion in any reagents herein (e.g., an anion, a counterion, a solvent, etc., and combinations thereof).

Methods for forming a reinforced membrane can include wetting a porous substrate in a liquid to form a wetted substrate; dissolving a compound (e.g., of formula (I) or any described herein) in a solvent to form a casting solution; applying the casting solution onto the wetted substrate to form the reinforced membrane; drying the reinforced membrane; and optionally exchanging anions of the reinforced membrane with anions (e.g., hydroxide ions) to form the reinforced membrane. The resulting reinforced membrane can be impregnated with the compound a number of times by wetting the reinforced membrane again and repeating the dissolving, applying, and drying steps.

### Uses

The compositions herein can be employed to form a material, such as a film or a membrane (e.g., an ion exchange membrane). The composition and material thereof can be employed within a device or apparatus, such as an electrochemical cell or an electrolyzer cell. In one embodiment, the cell includes an anode, a cathode, and a membrane disposed between the anode and the cathode. The membrane can include any composition or material described herein. In some embodiments, the membrane can be a reinforced membrane. In particular embodiments, the cell includes an electrolyte. In non-limiting embodiments, the electrolyte includes hydroxide.

As a person skilled in the art will recognize from the previous detailed description and from the figures and claims, modifications and changes can be made to the disclosed embodiments of the disclosure without departing from the scope of this disclosure defined in the following claims.

1. A compound comprising a structure of formula (I): 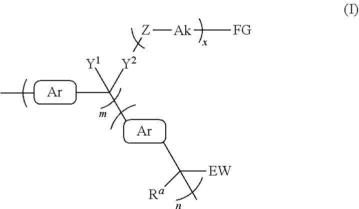
or a salt thereof,
wherein:
each Ar comprises, independently, an optionally substituted aromatic or optionally substituted arylene;
each Y¹ is, independently, EW and each Y² is, independently, Ak; or Y¹ and Y², taken together, comprises an optionally substituted heterocyclic amino;
each Z is, independently, selected from the group consisting of —O—, —S—, —NR^{N1}— —NR^{N1}R^{N2}—, and —CR^{C2}R^{C3}—, in which each of R^{N1}, R^{N2}, R^{C2}, and R^{C3} is, independently, H, optionally substituted alkyl, or optionally substituted aryl, and in which at least one Z is not —CR^{C2}R^{C3}— or in which at least one Z is not —N(CH₃)₂—;
each Ak is, independently, optionally substituted alkylene;
x is 1 to 20;
each FG is, independently, selected from the group consisting of optionally substituted alkyl, optionally substituted aryl, hydroxy, amino, ammonium cation, sulfo, sulfonate anion, phosphono, phosphonate anion, carboxyl, carboxylate anion, heterocyclic cation, or a salt form thereof;
each EW is, independently, selected from the group consisting of haloalkyl, optionally substituted heteroaryl, amino, amido, nitrile, and —C(═O)R^{C1}, in which R^{C1} is H, hydroxy, alkoxy, alkyl, or oxygen anion (O⁻);
each R^{a} is, independently, H, optionally substituted alkyl, optionally substituted aryl, or optionally substituted heteroaryl; and
each of m and n is, independently, 1 to 1,000,000.

2. The compound of claim 1, comprising a structure of formula (II): 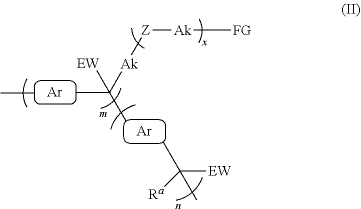
or a salt thereof.

3. The compound of claim 1, comprising a structure of formula (IIa): 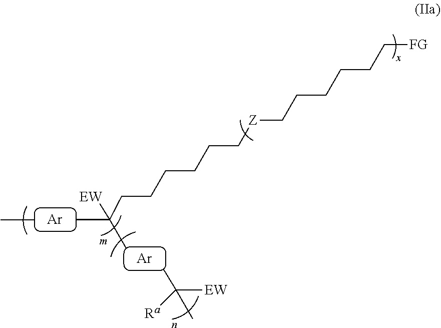
or a salt thereof.

4. The compound of claim 1, comprising a structure of formula (IIb): 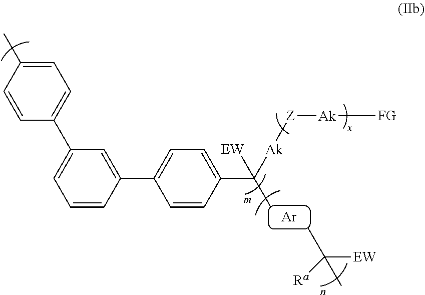
or a salt thereof.

5. The compound of claim 1, comprising a structure of formula (IIc): 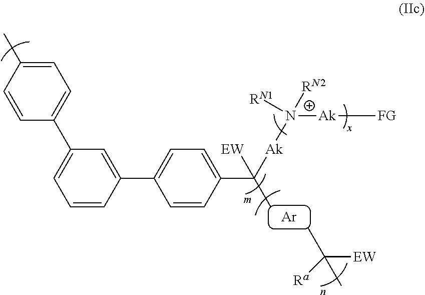
or a salt thereof.

6. The compound of claim 1, comprising a structure of formula (IId): 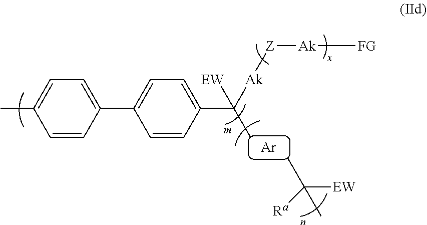
or a salt thereof.

7. The compound of claim 1, comprising a structure of formula (IIe): 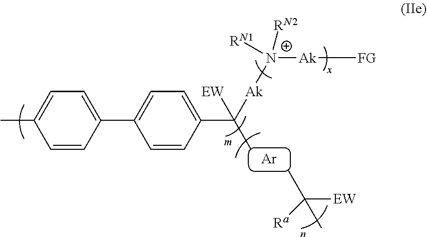
or a salt thereof.

8. The compound of claim 1, comprising a structure of formula (IIIa), (IIIb), or (IIIc): 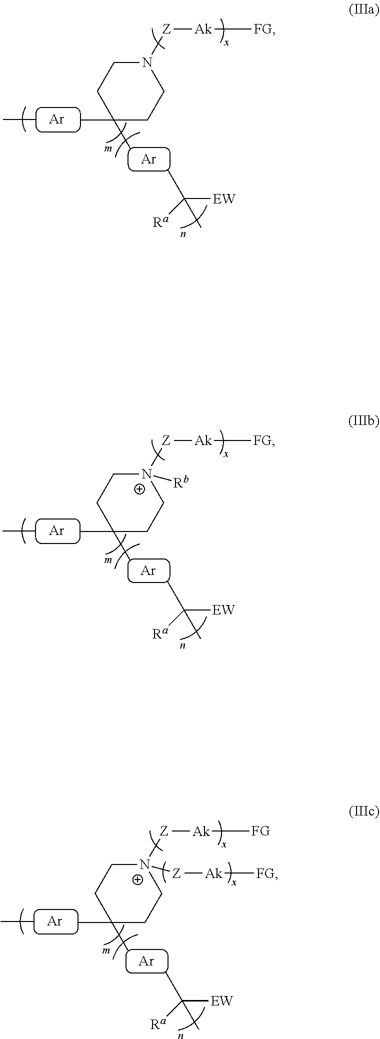
or a salt thereof, wherein each R^{b} is, independently, H, optionally substituted alkyl, or optionally substituted aryl.

9. The compound of claim 1, comprising a structure of formula (IVa), (IVb), or (IVc): 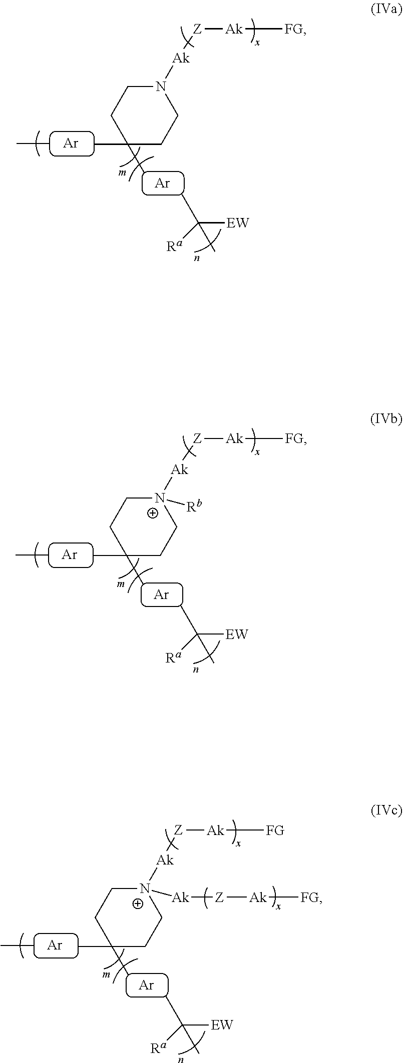
or a salt thereof, wherein each R^{b} is, independently, H, optionally substituted alkyl, or optionally substituted aryl.

10. The compound of claim 1, wherein Ar is selected from the group consisting of:

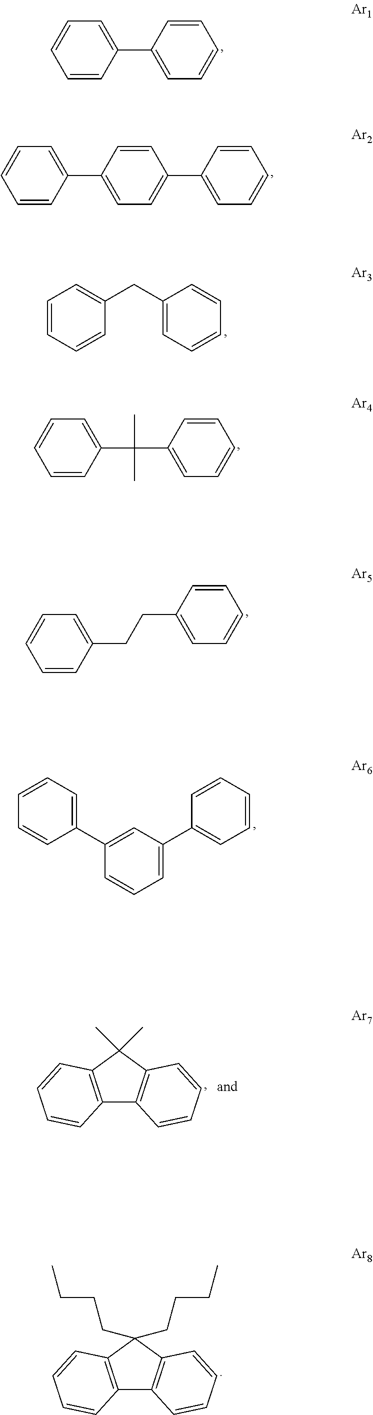

11. The compound of claim 1, wherein each EW is, independently, selected from the group consisting of CF₃, pyridine, heterocyclic amino, —C(═O)OH, amido, and nitrile.

12. The compound of claim 1, wherein each Ak is, independently, C₁₋₆ alkylene.

13. The compound of claim 1, wherein:
Z is selected from the group consisting of —O—, —S—, —NH—, and —CH₂—; and/or
FG is selected from the group consisting of CH₃, CH₂CH₃, alkyl, aryl, OH, NR^{N1}R^{N2}R^{N3} SO₃H, P(═O)(OH)₂, CO₂H, NR^{N1}R^{N2}R^{N3} Cl, and NR^{N1}R^{N2}R^{N3} Br, in which each of R^{N1}, R^{N2}, and R^{N3} is, independently, H, optionally substituted alkyl, or optionally substituted aryl.

14. The compound of claim 1_, wherein R^{a} is alkyl, haloalkyl, or substituted aryl.

15. The compound of claim 1_, wherein the salt form of FG comprises an anion.

16. A compound comprising a structure of formula (Va) or (Vb): 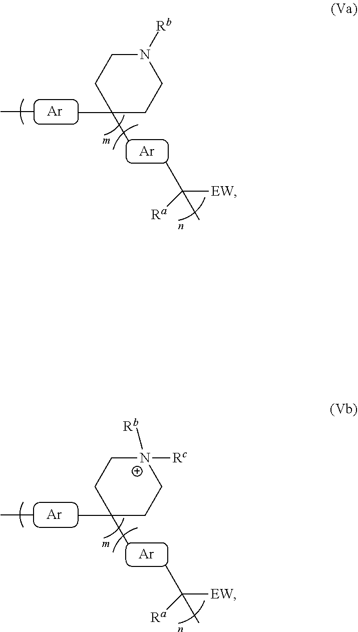
or a salt thereof,
wherein:
each Ar comprises, independently, an optionally substituted aromatic or optionally substituted arylene;
each EW is, independently, selected from the group consisting of haloalkyl, optionally substituted heteroaryl, amino, amido, nitrile, and
—C(═O)R^{C1}, in which R^{C1} is H, hydroxy, alkoxy, alkyl, or oxygen anion (O⁻);
each of R^{a}, R^{b}, and R^{c} is, independently, H, optionally substituted alkyl, or optionally substituted aryl, and in which at least one R^{a} is not unsubstituted phenyl; and optionally wherein R^{b} and R^{c}, taken together, form an optionally substituted alkylene or optionally substituted heteroalkylene; and
each of m and n is, independently, 1 to 1,000,000.

17. The compound of claim 16, wherein Ar comprises:

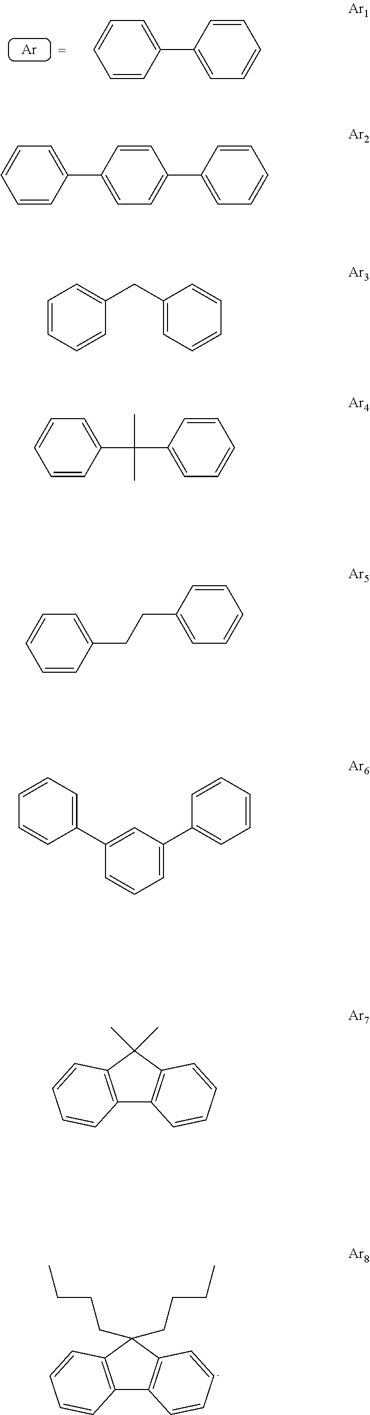

18. The compound of claim 16, wherein each EW is selected from the group consisting of CF₃, pyridine, heterocyclic amine, —C(═O)OH, amido, and nitrile.

19. The compound of claim 1, wherein the compound is free of ether linkages.

20. A composition comprising a compound of claim 1.

21. The composition of claim 20, wherein the composition comprises a polymer, a copolymer, a block copolymer, or a combination thereof.

22. The composition of claim 20, wherein the composition comprises a film or a membrane.

23. The composition of claim 20, wherein the composition has an electrolyte uptake of 40% or more; the composition is stable when immersed in 6M KOH at 120° C. for 7 days; the composition has a stress of at least 30 MPa and/or a strain of at least 40% prior to exposure to 6M KOH at 120° C. for 7 days; and/or the composition has a stress of at least 40 MPa and/or a strain of at least 5% after exposure to 6M KOH at 120° C. for 7 days.

24. A method of making a compound of claim 1, the method comprising:
reacting an aromatic compound, a first carbonyl agent, and a second carbonyl agent comprising an electron-withdrawing group in the presence of a strong acid to form a precursor polymer; and
reacting the precursor polymer in the presence of a grafting agent to form a polyarylene compound having a hydrophilic graft chain.

25. The method of claim 24, wherein the first carbonyl agent comprises an optionally substituted haloalkyl ketone or an optionally substituted piperidinone; and wherein the grafting agent comprises the —(Z-Ak)ₓ- moiety.

26. A method of making a compound of claim 16, the method comprising:
reacting an aromatic compound, a first carbonyl agent comprises an R^{b}-substituted ketone, and a second carbonyl agent comprising an electron-withdrawing group in the presence of a strong acid to form a polyarylene compound.

27. The method of claim 26, wherein the first carbonyl agent comprises an N-substituted piperidinone, in which the nitrogen atom of the piperidinone is substituted with the R^{b} group.

28. The method of claim 24, further comprising:
exchanging a first anion of the precursor polymer or the polyarylene compound with a second anion, wherein the first and second anions are different.
